(19) United States
(12) Patent Application Publication
(10) Pub. No.: US 2014/0150341 A1
(43) Pub. Date: Jun. 5, 2014

(54) Solar-Powered Planter Assembly

(71) Applicant: Charles Christopher Montgomery, Auburn, AL (US)

(72) Inventor: Charles Christopher Montgomery, Auburn, AL (US)

(73) Assignee: YOUNG'S PLANT FARM, INC., Auburn, AL (US)

(21) Appl. No.: 13/645,610

(22) Filed: Oct. 5, 2012

(51) Int. Cl. A01G 9/02

(52) U.S. Cl. CPC A01G 9/02
USPC 47/70; 47/65.5

(57) ABSTRACT

A solar-powered planter assembly includes a planter, a support structure removably connected to the planter, and a solar-powered lighting assembly removably connected to the support structure. The solar-powered lighting assembly includes a control circuit that causes a light included in the lighting assembly to turn on at night using power supplied by a rechargeable battery and a solar cell included in the lighting assembly to charge the rechargeable battery during the day.

### BACKGROUND OF THE INVENTION

The present invention relates generally to planters for holding flowers and plants. More specifically, the present invention pertains to a solar-powered planter assembly.

Planters are known in the art. These devices are used to hold various types of flowers and plants in order to beautify a home or office location. Unfortunately, these devices typically do not include any sort of lighting so they are not visible, and, as a result, cannot beautify a home or office, at night. Accordingly, there is a need for a way to beautify a home or office with flowers and plants during the day and at night.

### SUMMARY OF THE INVENTION

The present invention addresses this need by providing a solar-powered planter assembly having a light that illuminates the planter assembly and any flowers or plants it might contain at night. In one embodiment, the planter assembly includes a planter, a support structure removably connected to the planter, and a solar-powered lighting assembly removably connected to the support structure. The solar-powered lighting assembly includes a solar cell for charging a rechargeable battery when it is inserted into the lighting assembly, a light emitting diode (LED) for illuminating the planter, and a control circuit connected to the solar cell and the LED that turns the LED off and on during the day and night and causes the solar cell to charge the rechargeable battery during the day.

### BRIEF DESCRIPTION OF THE DRAWINGS

FIG. 1 is a front view showing one embodiment of the present invention.

FIG. 2 is a front view showing the embodiment in FIG. 1 with the trellis removed from the planter.

FIG. 3 is a front view showing the embodiment in FIG. 1 with the lighting assembly removed from the trellis.

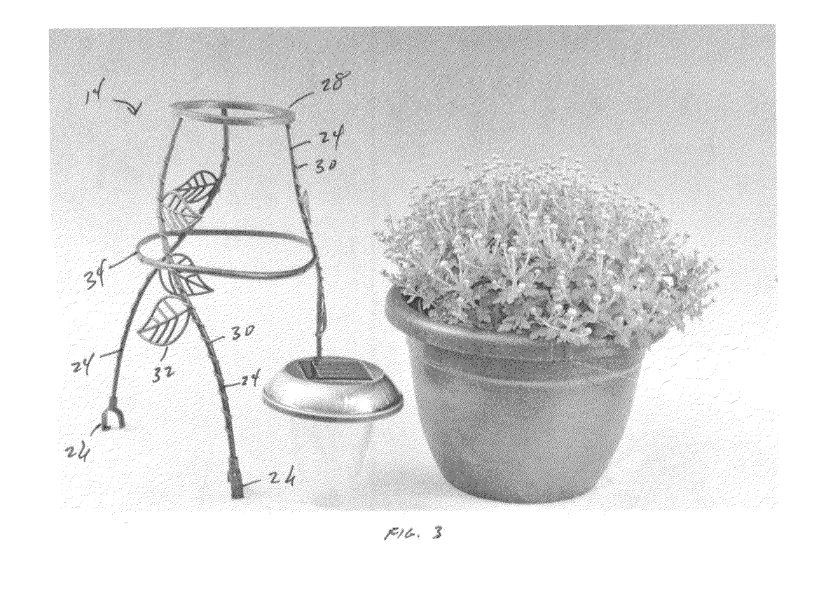

FIG. 4 is a front view showing the embodiment in FIG. 1 with the lid assembly and globe included with the lighting assembly separated from one another.

FIG. 5 is an enlarged view of the planter shown in FIG. 1.

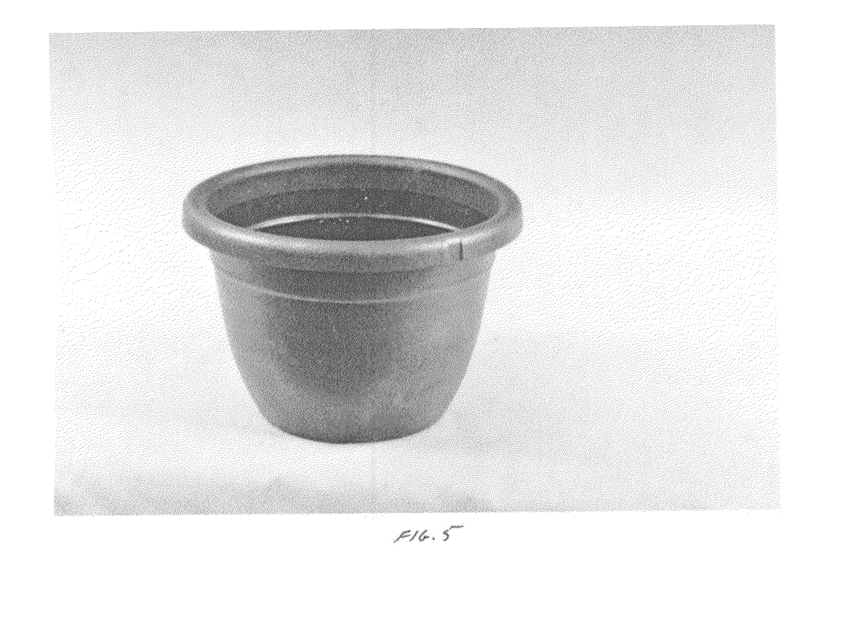

FIG. 6 is an enlarged view of the trellis shown in FIG. 1.

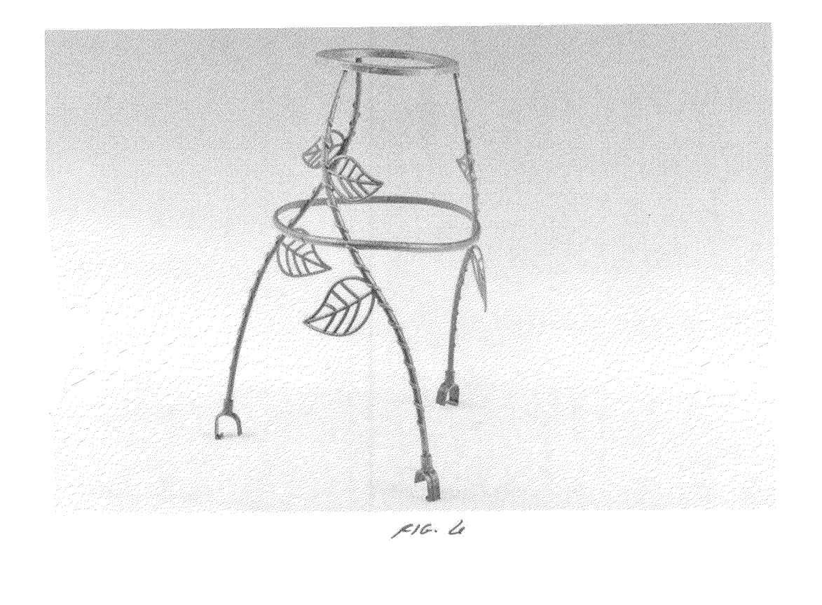

FIG. 7 is an enlarged view showing the upper portion of the trellis from FIG. 1.

FIG. 8 is an enlarged view showing the trellis from FIG. 1 laying its side.

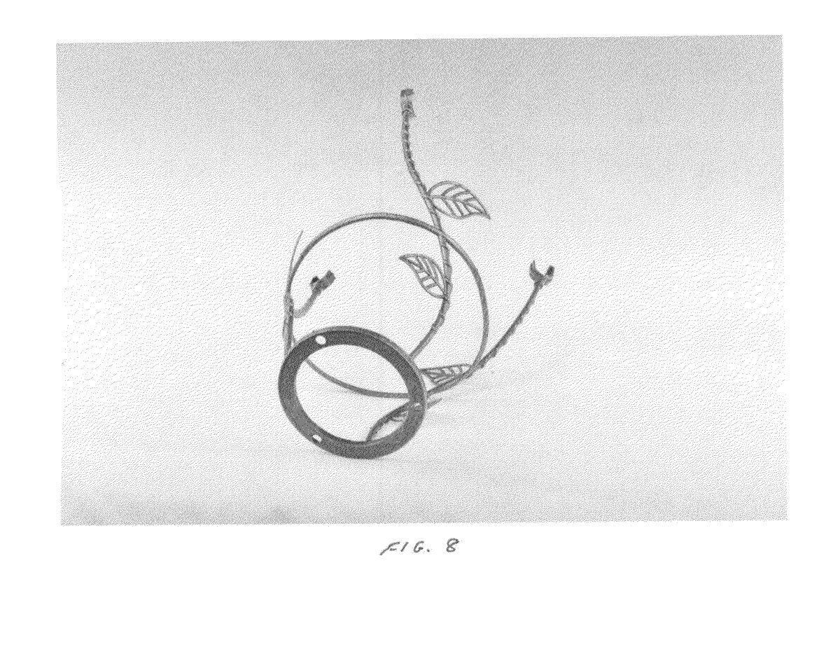

FIG. 9 is an enlarged view of the trellis shown in FIG. 1 showing the snap-on connectors included with the trellis.

FIG. 10 is an enlarged side view of the lid assembly included with the lighting assembly shown in FIG. 1.

FIG. 11 is an enlarged bottom view of the lid assembly showing the LED and rechargeable battery receptacle.

FIG. 12 is an enlarged view showing the lid assembly showing the top and bottom lid portions of the lid assembly.

FIG. 13 is a front view showing a second embodiment of the planter and trellis of the present invention.

FIG. 14 is a bottom view of the embodiment shown in FIG. 13.

FIG. 15 is an exploded front view of the embodiment shown in FIG. 13.

FIG. 16 is an enlarged view showing the snap-on connectors used with the embodiment shown in FIG. 13.

FIG. 17 is a front view of a second embodiment of the light assembly used with the present invention.

FIG. 18 is a bottom view of the embodiment shown in FIG. 17.

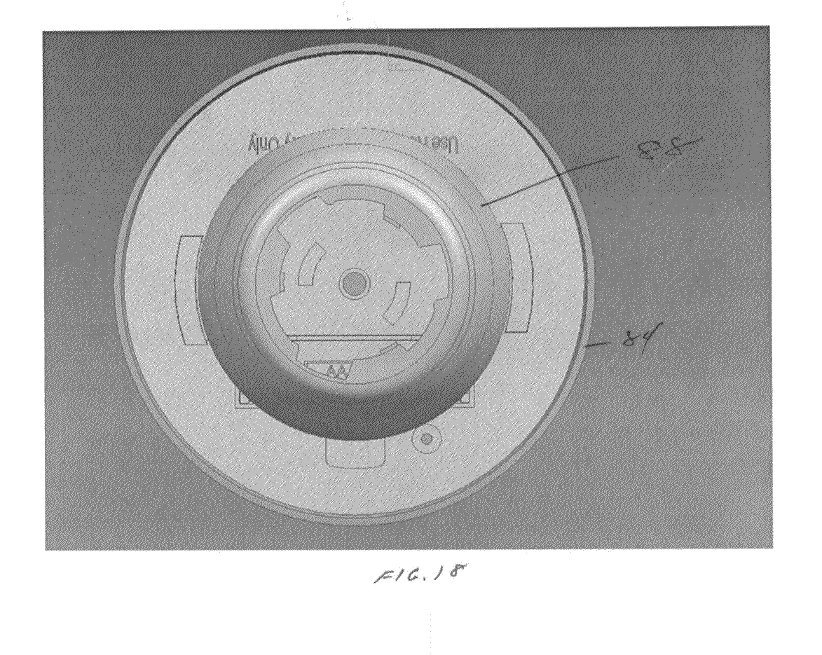

FIG. 19 is a side view of the embodiment shown in FIG. 17.

FIG. 20 is a side view of the embodiment of the globe shown in FIG. 17.

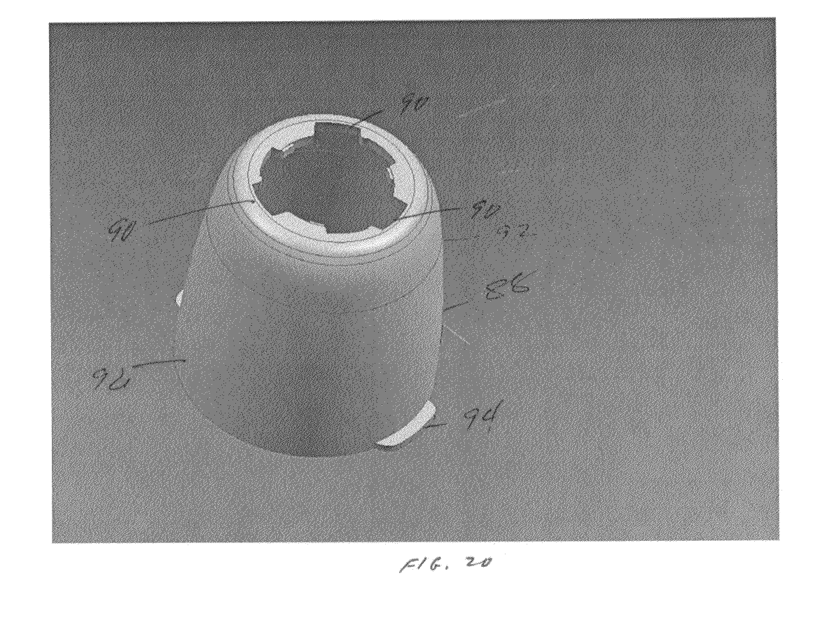

FIG. 21 is an enlarged bottom view of the embodiment of the lower lid portion shown in FIG. 17.

FIG. 22 is an enlarged top view of the embodiment of the lower lid portion shown in FIG. 17.

FIG. 23 is a bottom view of the embodiment of the upper lid portion shown in FIG. 17.

### DETAILED DESCRIPTION OF THE INVENTION

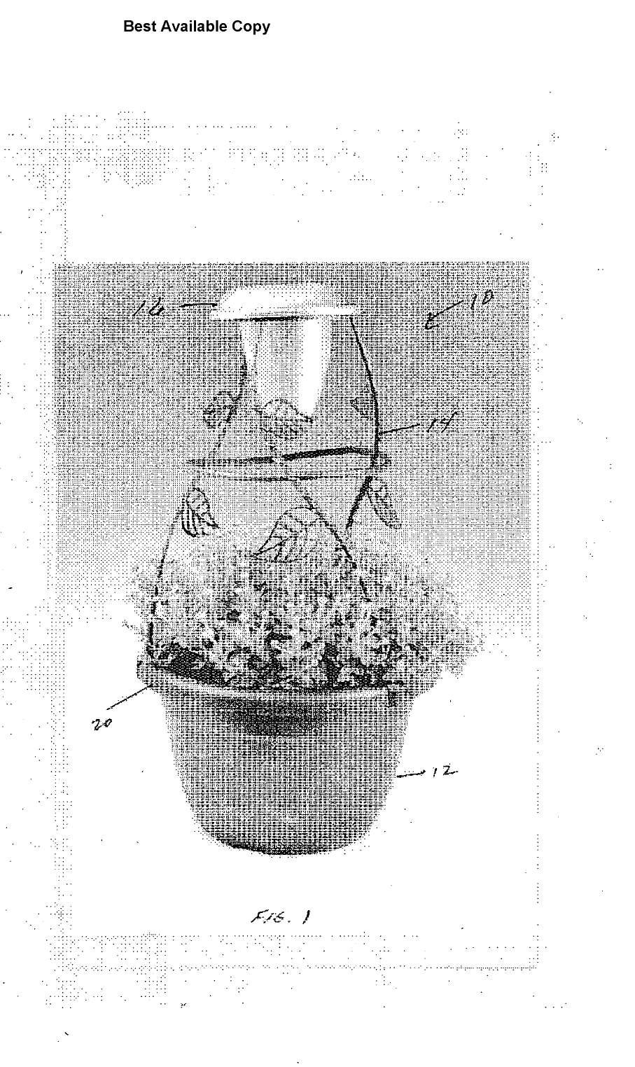

One embodiment of the present invention, solar-powered planter assembly 10, is shown in FIG. 1. This embodiment includes a planter 12, a support structure 14 (in this case, a trellis 14) removably connected to the planter 12, and a solar-powered lighting assembly 16 removably connected to the trellis 14.

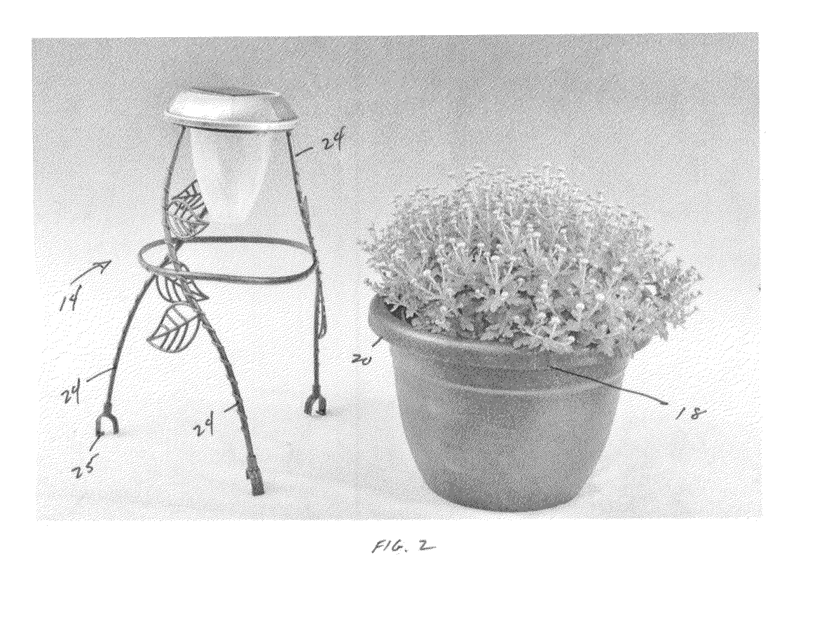

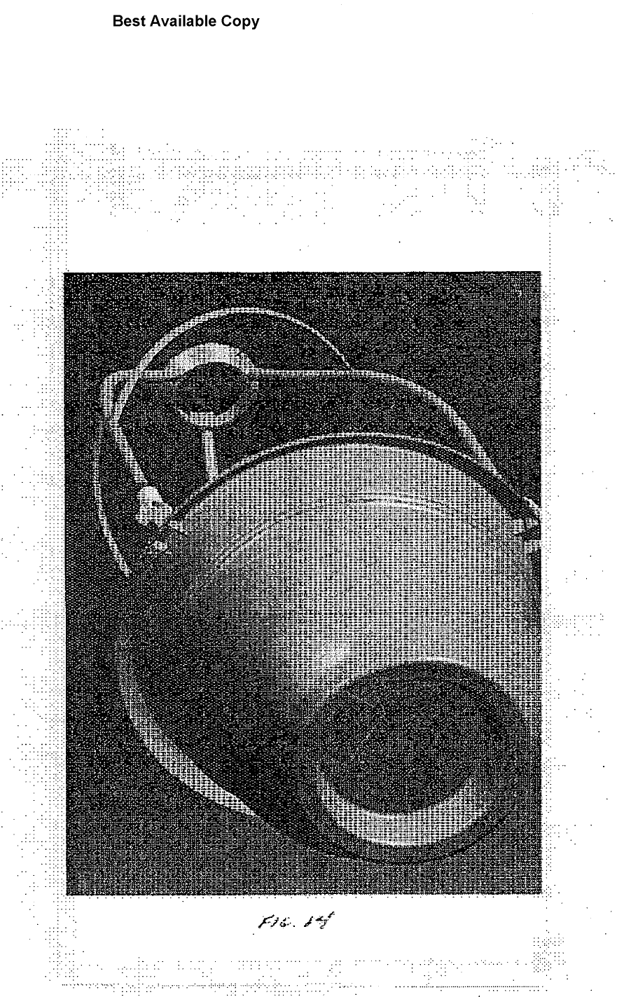

The planter 12 may be bowl-shaped and may include a series of indentations 18 (FIG. 2) spaced apart and defined in an upper lip 20. The planter 12 may also include a series of recesses 22 (FIG. 14) underneath the upper lip 20 opposite from the series of indentations 18. Trellis 14 may be connected to the upper lip 20 of planter 12 using the indentations 18 and recesses 22. Planter 12 may be manufactured out of plastic or other conventional materials used for manufacturing planters.

The trellis 14 may include three (3) curved, vertical legs 24 having snap-on connectors 26 connected on one end and a circular, top portion 28 connected to the other end. A vine-like structure 30 having one or more leaves 32 may be wrapped around each leg 24 between the snap-on connectors 26 and the circular top portion 28. The trellis 14 may also include a circular support structure 34 connected to the legs 24 between the snap-on connectors 26 and the circular top portion 28. In alternative embodiments (not shown), trellis 14 may be replaced with a post, a rod, a hook, a stake, an arbor, a lattice, or some other support structure that can be used to support the solar-powered lighting assembly 16. In still other embodiments, trellis 14 (or the other listed support structures) may be connected to other portions of the planter 12 (like an inner base portion) rather than the upper lip 20.

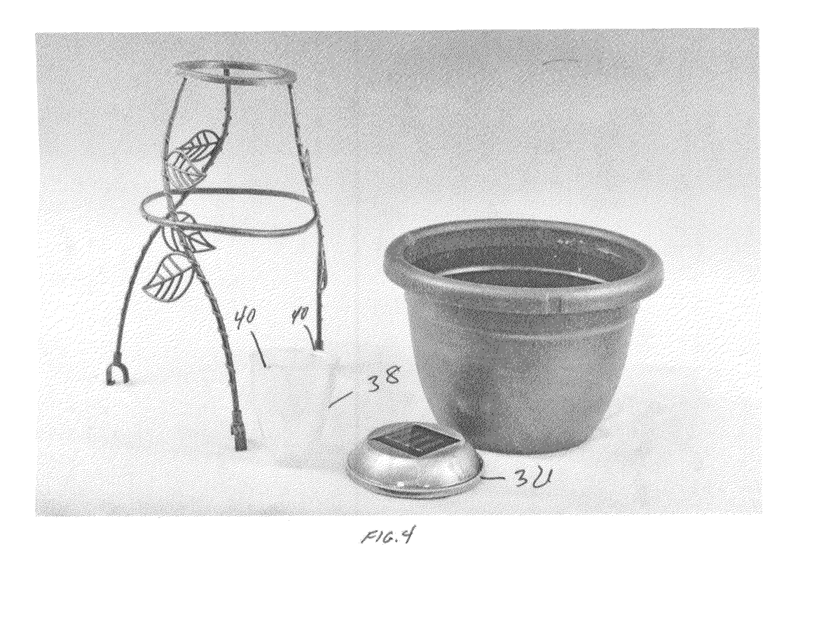

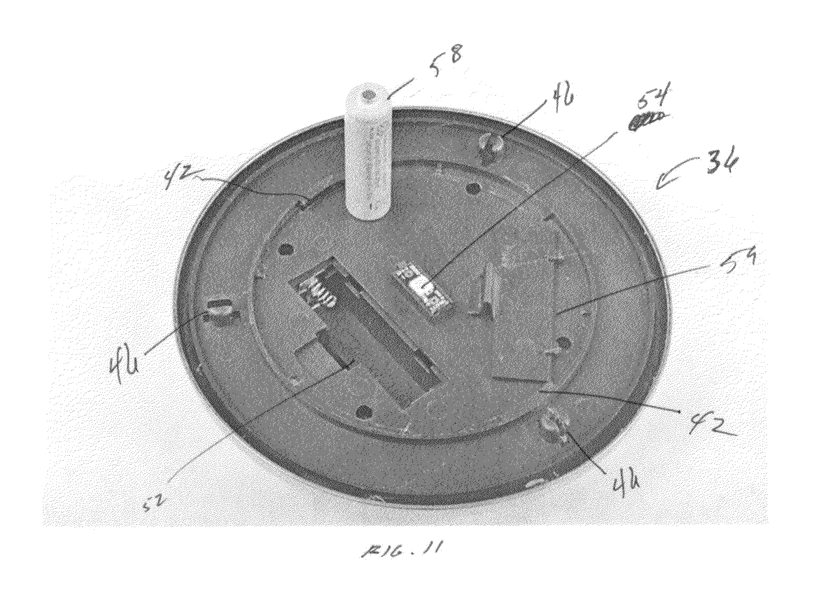

The solar-powered lighting assembly 16 (FIG. 4) may include a lid assembly 36 connected to a globe 38. The globe 38 may include a pair of tabs 40 and the lid assembly may include a pair of corresponding notches 42 (FIG. 11), both of which may be used to connect the globe 38 to the lid assembly 36 by placing the tabs 40 beside the notches 42 and rotating the globe 38 so that the tabs 40 engage with and are disposed within the notches 42. The globe 38 may be manufactured out of glass (having a cone shape) and may include a swirled pattern etched into the glass. In other embodiments, the globe 38 may be manufactured out of a plastic such as polyethylene.

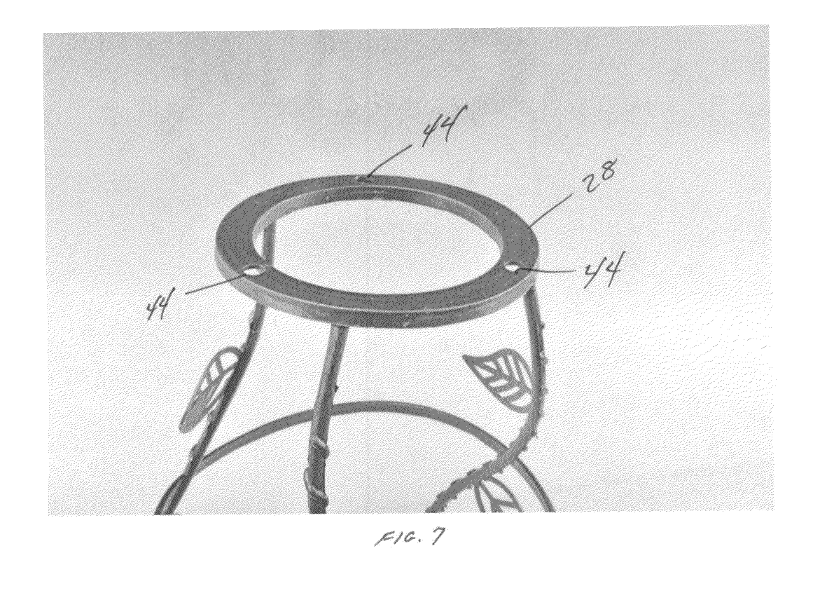

Referring to FIGS. 7 and 11, the circular top portion 28 may include a series of spaced apart openings 44 that are sized to receive a series of corresponding posts 46 defined in the lid assembly 36 when the lighting assembly 16 is connected to the trellis 14. The posts 46 prevent the lighting assembly 16 from rotating with respect to the trellis 14.

The lighting assembly 16 may be connected to the trellis 14 by inserting the globe 38 of the lighting assembly 16 into the circular top portion 28 of the trellis 14 and lowering the lighting assembly 16 until the lid assembly 36 comes into contact with and rests against the circular top portion 28.

The trellis 14 may be connected to the planter 12 by pressing the snap-on connectors 26 against the upper lip 20 of the planter 12 until an L-shaped portion 25 on each connector 26 snaps over a lower edge of the lip 20. The trellis 14 may be made of steel, aluminum, plastic, polyethylene, or any other suitable supporting material.

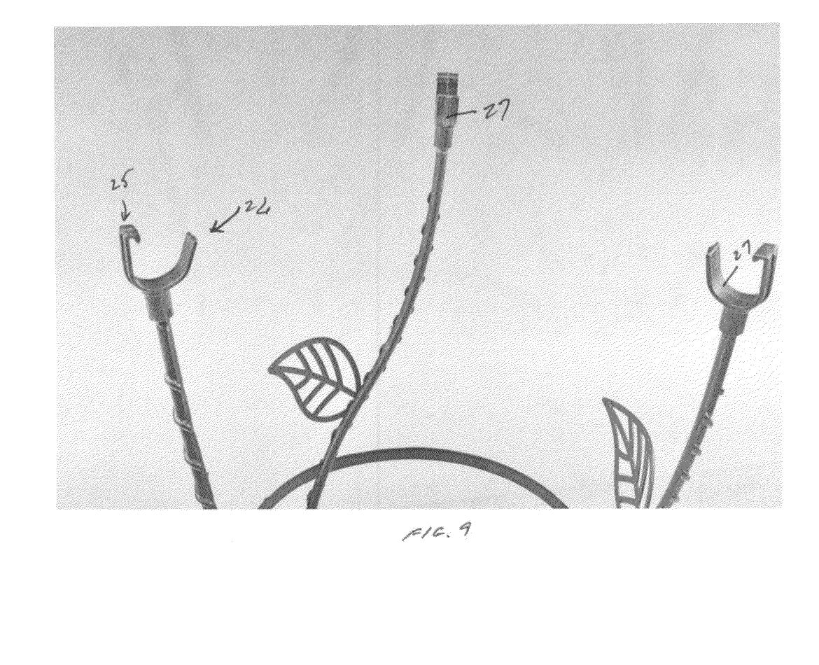

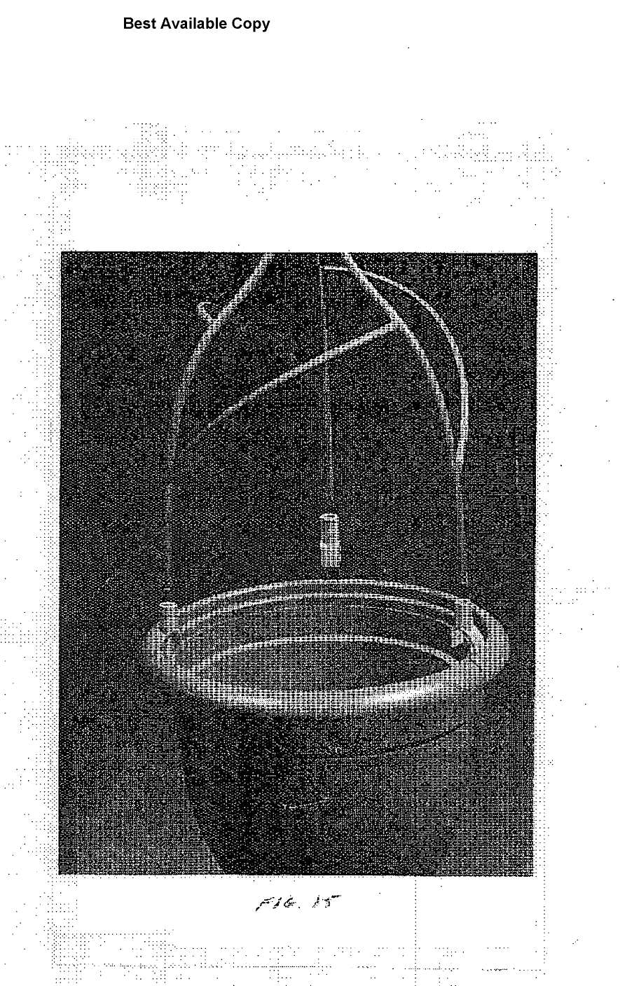

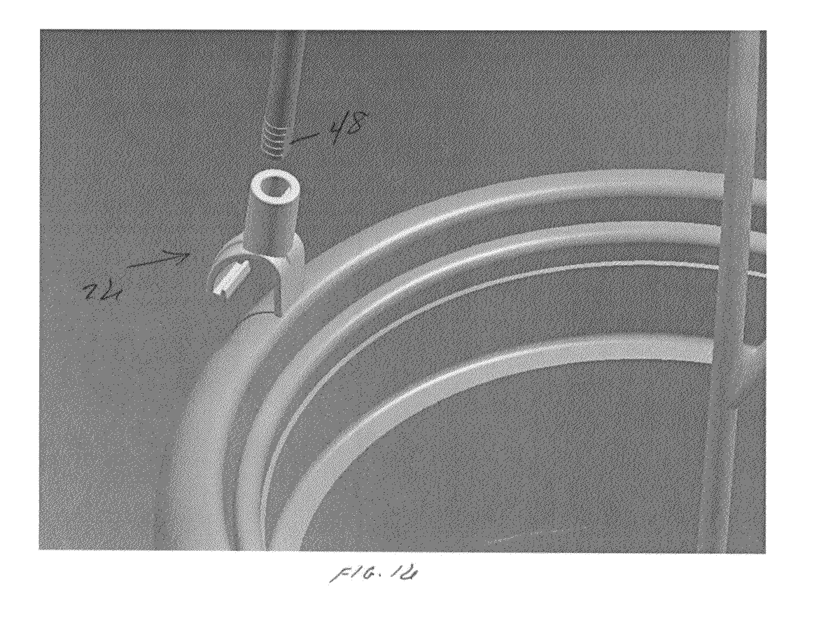

As shown in FIG. 9, the snap-on connectors 26 may be u-shaped and may include a ridge 27 extending outward from both an inner and outer surface. The snap-on connectors 26 may be connected to the trellis 14 using threads 48 (FIGS. 15-16) located on the lower portion of the trellis legs 24.

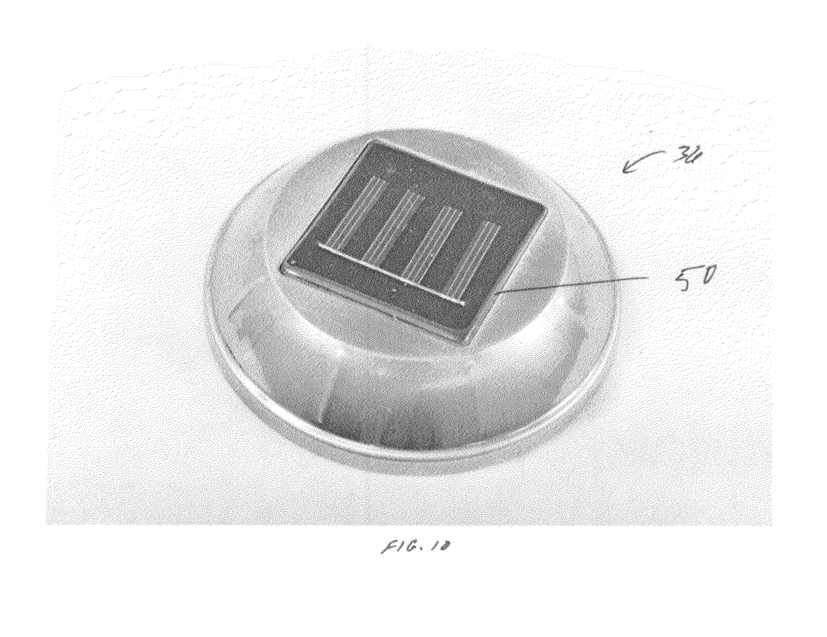

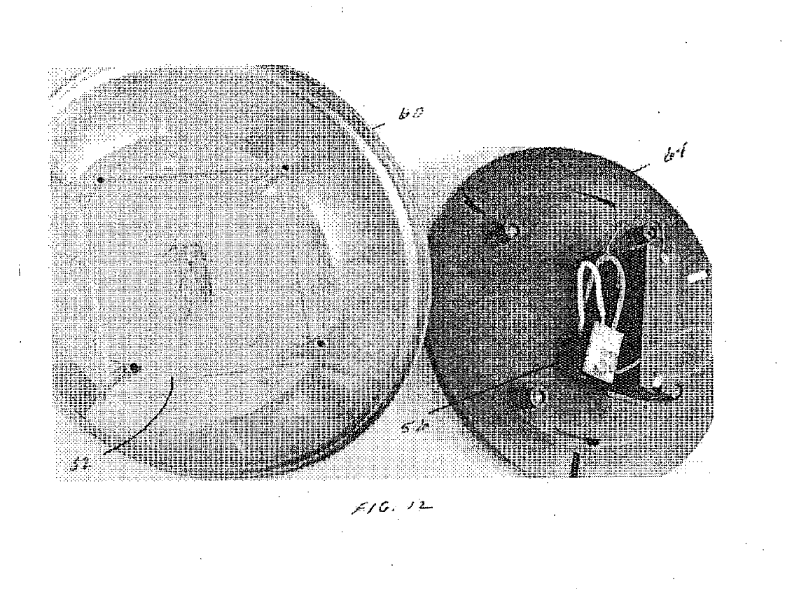

Referring to FIGS. 10-12, the lid assembly 36 may include a solar cell 50, a battery receptacle (or compartment) 52 connected to the solar cell 50, a light emitting diode (LED) 54 connected to the battery receptacle 52, and a control circuit 56 connected to the battery receptacle 52, LED 54, and solar cell 50. In one embodiment, the solar cell 50 is a 2 Volt-70 Milliamp solar cell manufactured by Hesen Panel (part number 6060), the LED 54 is a surface mount technology LED with a color temperature of 4000K manufactured by Kong Lighting Technology (part number S5050), and the control circuit 56 includes a circuit board (part number RS2139) manufactured by Zhenhua having an integrated circuit (part number 0116) and 150 microhenry inductor.

When rechargeable battery 58 is inserted into the battery receptacle 52, the control circuit 56 is operable to turn the LED 54 off during the day and on at night. In one embodiment, the rechargeable battery 58 is a 1.2 Volt, AA, Ni-Cd, 600 mAh battery manufactured by Sunrise. The control circuit 56 is also operable to cause the solar cell 50 to charge the rechargeable battery 58 during the day when the LED 54 is off. In one embodiment, the control circuit 56 senses when the solar cell 50 is generating a voltage and, when that happens, the control circuit 56 turns the LED 54 off and causes the voltage (and power) provided by the solar cell 50 to charge the rechargeable battery 58. When the solar cell 50 is not generating a voltage, the control circuit 56 turns the LED 54 on using power supplied by the rechargeable battery 58. Although an LED is used in this embodiment, other embodiments may use other types of lights as well, such as incandescent and fluorescent lights.

Lid assembly 36 may include a battery receptacle cover 59 to hold the rechargeable battery 58 in the lid assembly 36. The lid assembly 36 may include an upper lid portion 60 having a recessed portion 62 for receiving the solar cell 50 and a lower lid portion 64, which includes the notches 42, posts 46, and battery receptacle 52.

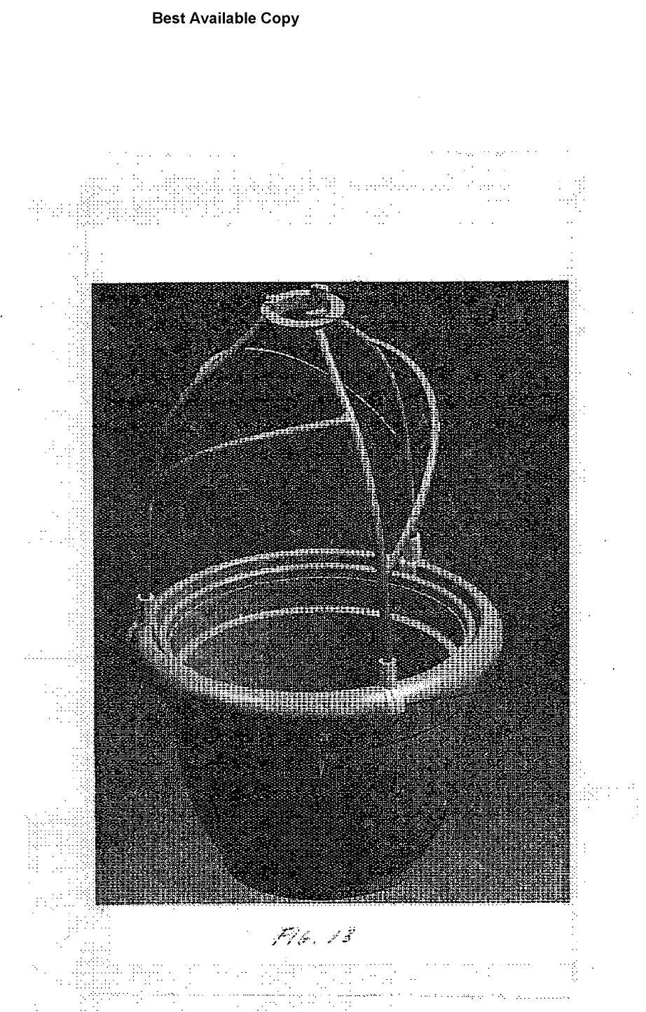

A second embodiment of the trellis and planter of the present invention, trellis 66 and planter 68, is shown in FIG. 13. Trellis 66 includes three (3) vertical legs 70, three (3) snap-on connectors 72 connected on a lower portion of each leg 70, and a tabbed circular top portion 74 connected to a top portion of each of the legs 70. The trellis 66 also includes a curved support structure 76 connected between each of the legs 70. The tabbed circular upper portion 74 may have a sloped lower portion 78 (FIG. 14) and three (3) tabs 79 extending outward from a flat upper surface 80.

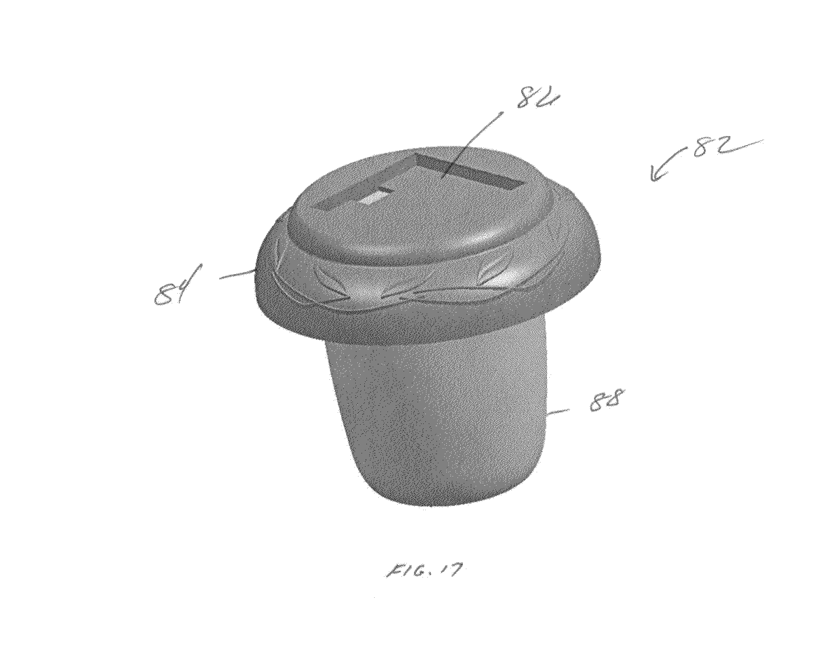

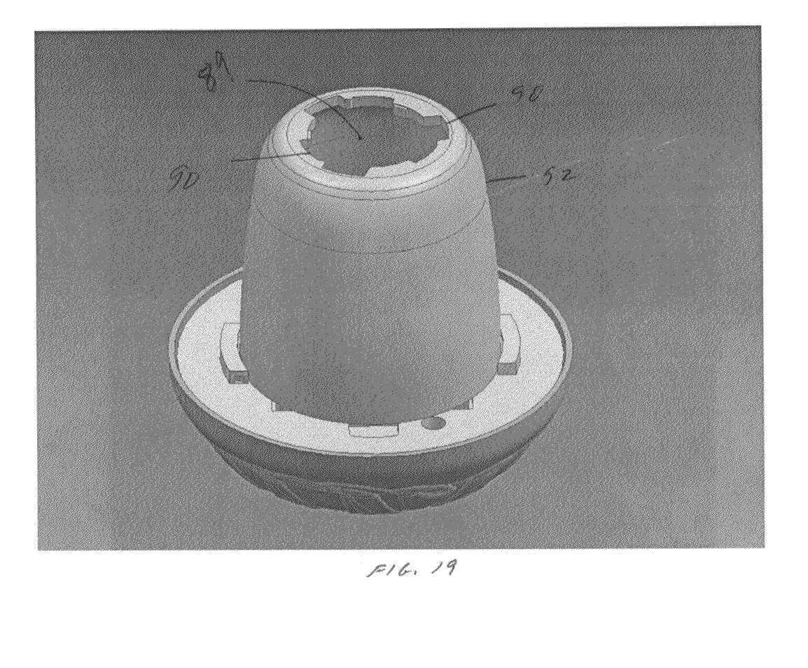

A second embodiment of the solar-powered lighting assembly of the present invention, solar-powered lighting assembly 82, is shown in FIG. 17. This embodiment includes a lid assembly 84 having a recess 86 for receiving a solar cell (not shown) and a globe 88. The globe 88 includes an opening 89 having a series of notches 90 defined in a lower portion 92 (FIG. 19). The notches 90 are sized so they can receive the tabs 79 defined in the trellis 66.

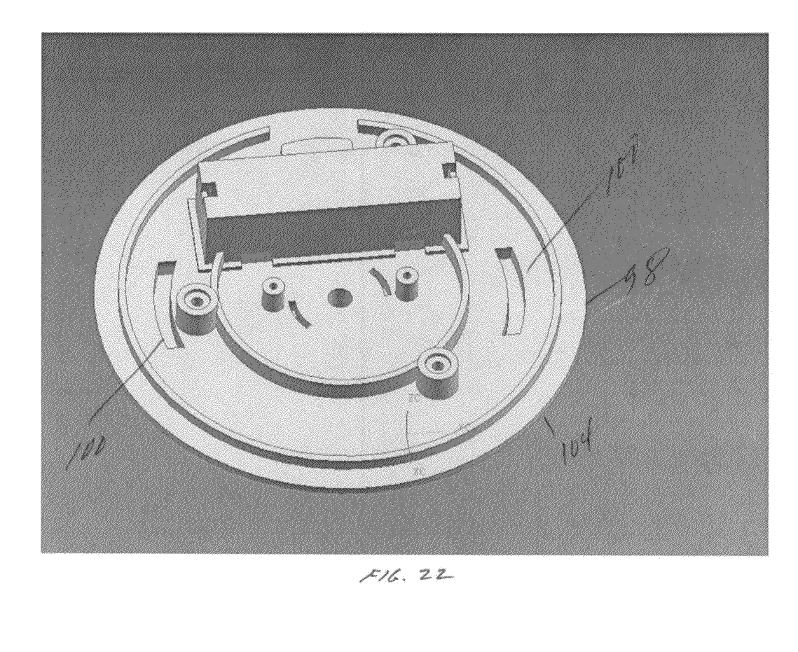

The globe 88 may be connected to the trellis 66 by inserting the tabs 79 through the opening 89 and rotating the globe 88 so the tabs 79 engage with the notches 90. Globe 88 may include a pair of tabs 94 extending outward from an upper portion 96 and a lower portion 98 (FIG. 22) of the lid assembly 84 may include a pair of corresponding notches 100. Globe 88 and lid assembly 84 may be connected together using the tabs 84 and notches 100.

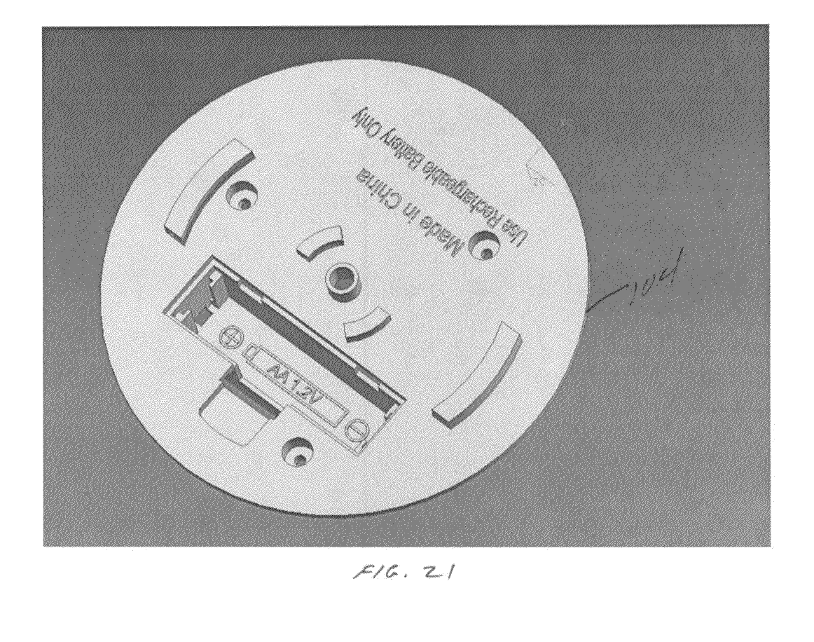

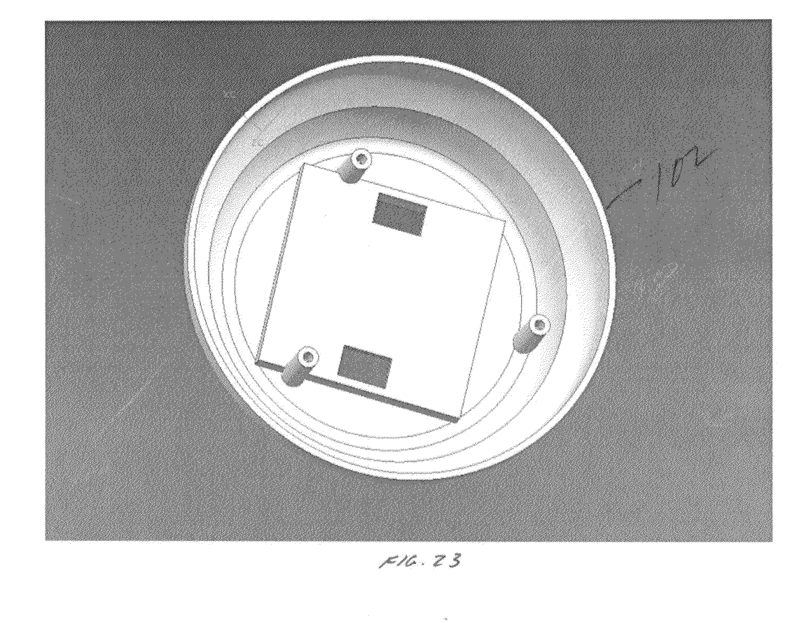

A second embodiment of the upper lid portion of the present invention, upper lid portion 102, is shown in FIG. 23. A second embodiment of the lower lid portion of the present invention, lower lid portion 104, is shown in FIGS. 21 and 22.

The above-described embodiments are merely possible examples of implementations set forth for a clear understanding of the principles of this disclosure. Many variations and modifications may be made to the above-described embodiments without departing substantially from the spirit and principles of the disclosure. All such modifications and variations are intended to be included herein within the scope of this disclosure and protected by the accompanying claims.

What is claimed is:

1. A planter assembly, comprising:
a planter;
a support structure removably connected to the planter; and
a solar-powered lighting assembly removably connected to the support structure.

2. The assembly of claim 1, wherein:
the planter is bowl-shaped and includes an upper lip having a plurality of indentions defined on an outer surface thereof and a plurality of recesses defined on an inner surface of the upper lip opposite from the plurality of indentations defined on the outer surface; and
the support structure is connected to the planter using the plurality of indentations and recesses.

3. The assembly of claim 2, wherein:
the support structure includes a trellis having a plurality of curved, vertical legs, a plurality of snap-on connectors connected to a lower portion of each one of the plurality of legs, and a circular top portion connected to an upper portion of the each one of the plurality of legs; and
the trellis is connected to the planter using the plurality of snap-on connectors.

4. The assembly of claim 3, further comprising:
a vine-like structure having one or more leaves extending therefrom wrapped around each one of the plurality of legs of the trellis; and
a circular support structure connected to the plurality of legs between the top and lower portions of the plurality of legs.

5. The assembly of claim 4, wherein each snap-on connector has a u-shaped body having two legs, a ridge extending outward from an outer surface, and an L-shaped lip extending inward from one of the legs of the u-shaped body.

6. The assembly of claim 5, wherein the solar-powered lighting assembly includes a cone-shaped globe connected to a lid assembly.

7. The assembly of claim 6, wherein a plurality of posts extend outward from a bottom portion of the lid assembly and a plurality of openings sized to receive the plurality of posts is defined in the circular top portion of the trellis.

8. The assembly of claim 7, wherein:
the lid assembly includes a solar cell mounted on an upper lid portion, a battery receptacle for receiving a rechargeable battery defined in a lower lid portion and electrically connected to the solar cell, a light emitting diode (LED) electrically connected to the battery receptacle and extending outward from a bottom portion of the lower lid portion, and a control circuit electrically connected to the solar cell, LED, and battery receptacle; and
when the rechargeable battery is inserted into the battery receptacle, the control circuit turns off the LED during daylight hours and charges the rechargeable battery using power supplied by the solar cell, and turns on the LED during nighttime hours using power supplied by the rechargeable battery and stops charging the rechargeable battery.

9. The assembly of claim 8, wherein the globe includes a pair of tabs extending outward from an upper portion, the bottom of the lower lid portion of the lid assembly includes a pair of notches defined therein, and, when the globe and lid assembly are connected together, the tabs are disposed within the notches.

10. A solar-powered planter assembly, comprising:
a planter;
a trellis removably connected to the planter, the trellis including a plurality of curved, vertical legs, a plurality of snap-on connectors connected to a lower portion of each one of the plurality of legs, a circular top portion connected to an upper portion of each one of the plurality of legs, a vine-like structure having one or more leaves extending therefrom wrapped around each one of the plurality of legs of the trellis, and a circular support structure connected to the plurality of legs between the top and lower portions of the plurality of legs; and
a solar-powered lighting assembly removably connected to the trellis.

11. The assembly of claim 10, wherein each snap-on connector has a u-shaped body having two legs, a ridge extending outward from an outer surface, and an L-shaped lip extending inward from one of the legs of the u-shaped body.

12. The assembly of claim 10, wherein:
the solar-powered lighting assembly includes a globe connected to a lid assembly, the globe including a pair of tabs extending outward from an upper portion of the globe, the lid assembly includes a lower lid portion having a pair of notches defined therein, and, when the globe and lid assembly are connected together, the tabs are disposed within the notches; and
a plurality of posts extend outward from the lower lid portion and a plurality of openings sized to receive the plurality of posts is defined in the circular top portion of the trellis.

13. The assembly of claim 12, wherein:
the lid assembly includes a solar cell mounting on an upper lid portion, a battery receptacle for receiving a rechargeable battery defined in the lower lid portion and electrically connected to the solar cell, a light emitting diode (LED) electrically connected to the battery receptacle and extending outward from a bottom portion of the lower lid portion, and a control circuit electrically connected to the solar cell, LED, and battery receptacle; and
when the rechargeable battery is inserted into the battery receptacle, the control circuit turns off the LED during daylight hours and charges the rechargeable battery using power supplied by the solar cell, and turns on the LED during nighttime hours using power supplied by the rechargeable battery and stops charging the rechargeable battery.

14. The assembly of claim 13, wherein:
the planter is bowl-shaped and includes an upper lip having a plurality of indentions defined on an outer surface thereof and a plurality of recesses defined on an inner surface of the upper lip opposite from the plurality of indentations defined on the outer surface; and
the trellis is connected to the planter using the plurality of indentations and recesses.

15. A solar-powered planter assembly, comprising:
a planter;
a support structure removably connected to the planter;
a solar-powered lighting assembly removably connected to the support structure, the solar-powered lighting assembly including a globe connected to a lid assembly, the lid assembly including a solar cell mounted on an upper lid portion, a battery receptacle for receiving a rechargeable battery defined in a lower lid portion and electrically connected to the solar cell, a light emitting diode (LED) electrically connected to the battery receptacle and extending outward from a bottom portion of the lower lid portion, and a control circuit electrically connected to the solar cell, LED, and battery receptacle; and
wherein, when the rechargeable battery is inserted into the battery receptacle, the control circuit turns off the LED during daylight hours and charges the rechargeable battery using power supplied by the solar cell, and turns on the LED during nighttime hours using power supplied by the rechargeable battery and stops charging the rechargeable battery.

16. The assembly of claim 15, wherein the globe includes a pair of tabs extending outward from an upper portion, the lower lid portion of the lid assembly includes a pair of notches defined therein, and, when the globe and lid assembly are connected together, the tabs are disposed within the notches.

17. The assembly of claim 16, wherein:
the planter is bowl-shaped and includes an upper lip having a plurality of indentions defined on an outer surface thereof and a plurality of recesses defined on an inner surface of the upper lip opposite from the plurality of indentations defined on the outer surface; and
the support structure is connected to the planter using the plurality of indentations and recesses.

18. The assembly of claim 17, wherein the support structure includes a trellis having a plurality of vertical legs, a plurality of snap-on connectors connected to a lower portion of each one of the plurality of legs, a circular top portion connected to an upper portion of the each one of the plurality of legs, and a curved support structure connected between each one of the plurality of legs.

19. The assembly of claim 18, wherein each snap-on connector has a u-shaped body having two legs, a ridge extending outward from an outer surface, and an L-shaped lip extending inward from one of the legs of the u-shaped body.

20. The assembly of claim 19, wherein the globe includes a plurality of notches defined in a lower portion, the circular top portion of the trellis includes a plurality of tabs, and, when the globe is connected to the trellis, the plurality of tabs are disposed within the plurality of notches.
